(19) United States
(12) Patent Application Publication
(10) Pub. No.: US 2016/0306967 A1
(43) Pub. Date: Oct. 20, 2016

(54) Method to Detect Malicious Behavior by Computing the Likelihood of Data Accesses

(71) Applicant: Symantec Corporation, Mountain View, CA (US)

(72) Inventors: Michael Hart, Farmington, CT (US); Chetan Verma, Sunnyvale, CA (US); Sandeep Bhatkar, Sunnyvale, CA (US); Aleatha Parker-Wood, Redwood City, CA (US)

(21) Appl. No.: 14/690,171

(22) Filed: Apr. 17, 2015

(51) Int. Cl. G06F 21/56

(52) U.S. Cl. CPC G06F 21/56; G06F 2221/034

(57) ABSTRACT

A method, performed by a processor to detect malicious or risky data accesses is provided. The method includes modeling user accesses to a content repository as to probability of a user accessing data in the content repository, based on a history of user accesses to the content repository. The method includes scoring a singular user access to the content repository, based on probability of access according to the modeling and alerting in accordance with the scoring.

### BACKGROUND

Malicious insider activity is difficult to detect, and an insider with access to files in a content repository may be able to copy, send, alter or delete large amounts of data without getting caught or prior to being caught. Proposed systems to address malicious insiders establish a threshold of a “reasonable number” of files to access in a given time span, and alert a security administrator if a user exceeds this reasonable number of files. While this detects malicious access of an excessive number of files, such a system may fail to detect a lesser number of malicious accesses. Setting a threshold of a reasonable number of files too low will likely generate too many false positives.

It is within this context that the embodiments arise.

### SUMMARY

In some embodiments, a method, performed by a processor to detect malicious or risky data accesses is provided. The method includes modeling user accesses to a content repository as to probability of a user accessing data in the content repository, based on a history of user accesses to the content repository. The method includes scoring a singular user access to the content repository, based on probability of access according to the modeling and alerting in accordance with the scoring.

In some embodiments, a tangible, non-transitory, computer-readable media having instructions thereupon which, when executed by a processor, cause the processor to perform a method. The method includes training a probabilistic model of data accesses, using a history of user accesses to a content repository and monitoring user accesses to the content repository. The method includes scoring each user access of a plurality of user accesses to data in the content repository as to how probable the user access is according to the probabilistic model and alerting in accordance with the scoring.

In some embodiments, a detection system for data accesses is provided. The system includes a server having a modeling module, a scoring module and an alerting module, and configured to receive information about user accesses to a content repository, for both history and ongoing monitoring. The modeling module is configured to produce a probabilistic model of user accesses to data in the content repository based on the history. The scoring module is configured to produce a score of a user access to the content repository, based on the ongoing monitoring and based on how probable is the user access to the content repository according to the probabilistic model. The alerting module is configured to issue an alert based on a result of the scoring module.

Other aspects and advantages of the embodiments will become apparent from the following detailed description taken in conjunction with the accompanying drawings which illustrate, by way of example, the principles of the described embodiments.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a system diagram showing a detection system, with a server monitoring user accesses of a content repository, in accordance with some embodiments.

FIG. 2 is a block diagram depicting a modeling module of the server of FIG. 1, generating a model database that is based on an access history that has file type information and user information in accordance with some embodiments.

FIG. 3A shows the server of FIG. 1 requesting and receiving access information from the content repository in accordance with some embodiments.

FIG. 3B shows the server of FIG. 1 receiving access information via an application programming interface (API) in accordance with some embodiments.

FIG. 3C shows the server of FIG. 1 receiving access information that is pushed by a data monitoring or governing tool in accordance with some embodiments.

FIG. 3D shows the server of FIG. 1 receiving access information that is pushed by a streaming tool in accordance with some embodiments.

FIG. 4 is a flow diagram of a method to detect malicious or risky data accesses, which can be practiced on or by the detection system of FIGS. 1-3D in accordance with some embodiments.

FIG. 5 is an illustration showing an exemplary computing device which may implement the embodiments described herein.

### DETAILED DESCRIPTION

A detection system that computes the likelihood of data accesses and detects malicious or risky behavior, e.g., malicious or risky data accesses by a user, is described below. The system generates a probabilistic model of user accesses of data (e.g., raw data, databases, files, etc.) in a content repository. On an ongoing basis, the system monitors user accesses of the content repository, by pulling access information from, or receiving access information that is pushed by, the content repository. User accesses are individually scored based on the likelihood (i.e., probability according to the model) of that user access of that data at that time or span of time. The system issues an alert if a user access and corresponding score meet conditions set in one or more rules. Thus, the system increases the granularity of identifying malicious or risky data accesses to an individual user access of specific data in a content repository, as compared to detection systems that look for aggregate data access behavior such as accessing greater than a specified number of files in a specified amount of time. In some embodiments, a probabilistic model is trained on the data accesses of users to score how usual or unusual a user data access is. A scoring system analyzes user data accesses in near-real time and provides a likelihood determination for each datum/user pair. A reporting system may alert administrators based on users, files or repositories that exhibit an excessive amount of anomalous activity. Various embodiments with various features are described below, and further embodiments can employ various combinations of these features.

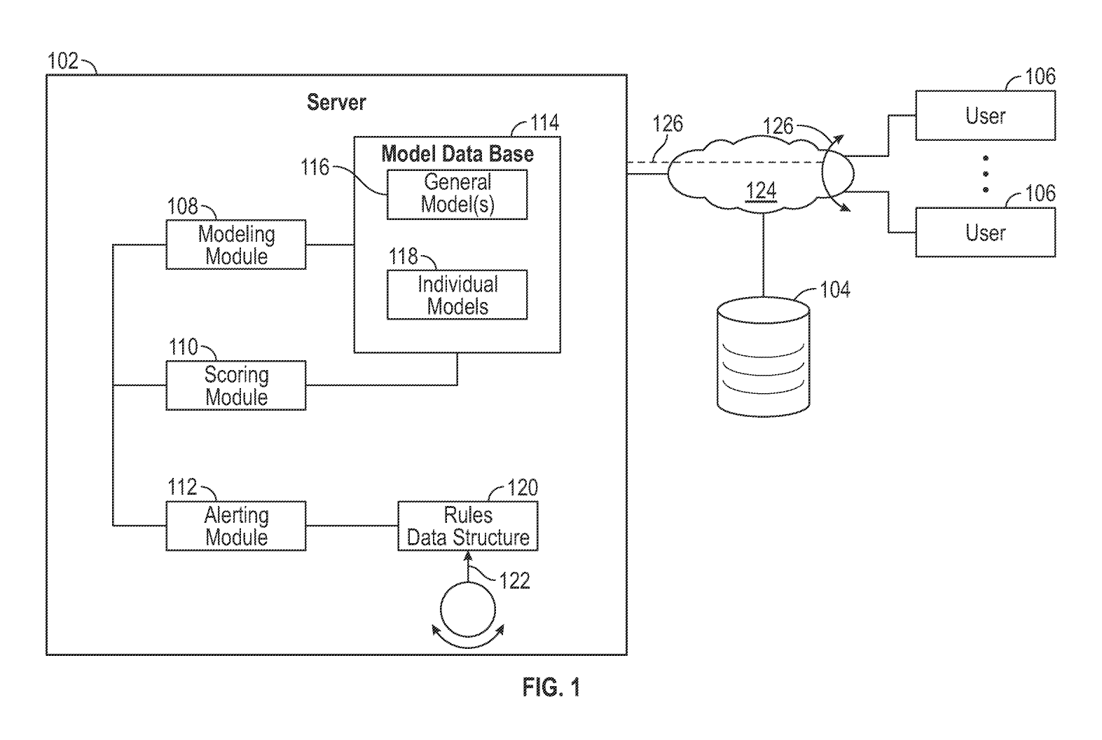

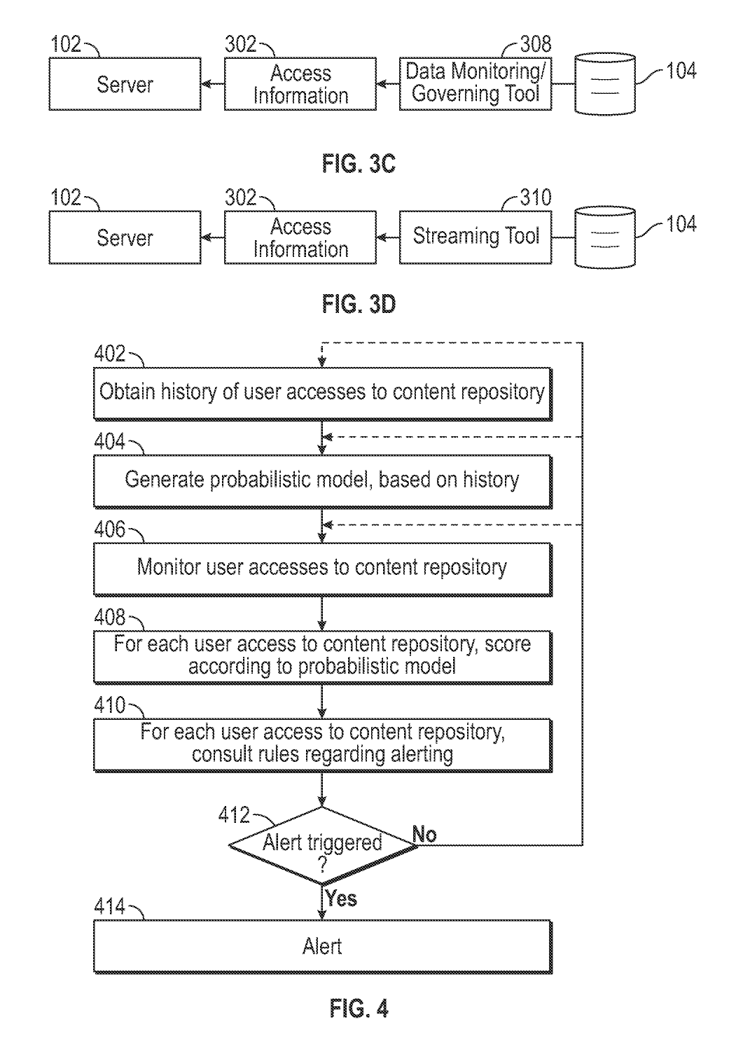

FIG. 1 is a system diagram showing a detection system, with a server 102 monitoring user accesses of a content repository 104, in accordance with an embodiment of the present disclosure. Users 106 are accessing data in the content repository 104, via a network 124, as depicted by the double headed arrow 126. For example, the network 124 could be an intranet, an internet, or the global communication network known as the Internet. The content repository 104 could be system memory, storage memory, a data storage, a file storage, a server, a storage system, etc. The server 102 implementing the detection system receives information about the user accesses to the content repository 104 via a path 126 (depicted as dashed lines), which will be further discussed with reference to FIGS. 3A-3D. Server 102 could include the content repository 104, couple to the content repository 104 or be separate from the content repository 104, in some embodiments.

Prior to the ongoing monitoring of user accesses, or alternatively during the ongoing monitoring of user accesses, the server 102 develops a probabilistic model of user accesses, which is written into a model database 114. In the embodiment shown in FIG. 1, a modeling module 108 generates one or more general models 116, and one or more individual models 118, as shown in the model database 114. For example, a general model 116 could be general across multiple users, but be specific to types of data, e.g., file types, data of types of subject matter, types of data in types of databases, etc. An individual model 118 could be specific to an individual user or users, or specific groups of users, etc. By analyzing patterns of user access of data in the content repository 104, the modeling module 108 can generate one or more models for the model database 114 that quantify the probability of a general user or a specific user accessing general data, various types of data, or various specific pieces of data of the content repository 104, in various embodiments.

Using recent activity for a specified content repository 104, the modeling module 108 trains a model or models 116, 118 of datum access for users 106. As an example, consider the context of a file server, where the data are files. Therefore, for each file, a model could compute how likely it is for a given user to access that specific file at this time. It should be appreciated that this example is not meant to be limiting as there are many ways to train this model. A simple model, which would be oblivious to the specific file and user, could be a function of the age of the file. Knowing that a file is this many days old, a probability density function could be modeled to estimate the likelihood of an access by any user at this time. For example, a relatively newer file is more likely to be accessed by people working on that file or making use of the contents of that file, and less likely to be accessed by people who are working in other areas. A relatively older file is less likely to be accessed in general, but might be more likely to be accessed by people who are working on a next-generation version of related subject matter. In various embodiments, the models can become progressively more nuanced. For example, given that the file has a specific extension, and is created by a specific person, it can be determined as to what is the likelihood that someone from line of business X would access that file. The challenge of finding the optimal model is orthogonal to the purposes of the present description, since the modeling is contingent on a variety of factors individual to each content repository 104.

Continuing with reference to FIG. 1, in the embodiment shown a scoring module 110 scores individual user accesses of the content repository 104 according to the model(s) 116, 118 in the model database 114. As an illustration of this process, consider a specific user 106 accessing a specific file or specific data of a specific database, etc., of the content repository 104. The data could be recently written data, data that has been there a long time (older data), data of a financial nature, video data, personal information data, design data, corporate data, archived emails, product information, an internal document, a public document, etc. This particular user access could be the first to this type of data in a long time, or could be the second or third access in a relatively shorter amount of time to this type of data, etc. In various embodiments, the models 116, 118 could model the probability that a general user or that a specific user would access this particular data or type of data in various time spans, and the scoring module 110 would then generate a score for that particular access.

The scoring module 110 focuses on the scoring of anomalous activity for each user session with the content repository 104. Ideally, the scoring should give a sense of the severity of the incident. For each datum access, a model 116, 118 can be applied to provide the likelihood of that access by that user at that time. The scoring module 110 will sum up a score based on this likelihood for some time interval. The score for the datum file access is a function of the probability. Many different scoring functions can be used, and one should be selected that best suits not only the activity, but the bandwidth of the security administrator to process events (e.g., if the administrator has little time to process events, then a function can be employed that only penalizes extremely anomalous activity). In one implementation, a function can be devised so that if the probability is greater than or equal to some threshold alpha, the score is zero. In one embodiment, the score is the natural logarithm of the inverse probability. This would give a high score to an occurrence of an event that has a very low probability, which is a good candidate for an alert. Other bases for logarithmic functions, or other mathematical functions could be used as the examples provided are not meant to be limiting.

Additionally, in further embodiments, a weighted score could be based on the sensitivity of a file being accessed. Sensitivity could be automatically determined (e.g., generated by the scoring module 110) based on factors such as metadata and content (e.g., finance and legal documents are more sensitive than HR (human resources) documents) and access pattern (e.g., a file accessed by a few users is more sensitive than a file that is accessed by a large number of users; access by one user to a file created by another user is more sensitive than access to one's own file, etc.). Alternatively, sensitivity of a file could be determined and communicated by a data loss prevention (DLP) service or module (e.g., credit card numbers or Social Security numbers have higher sensitivity than product pricing information or product reviews). The interval for activity may be fixed (e.g. each hour, each day) or could be dynamic and defined as a function (e.g. a session, where a session is terminated by an hour of inactivity). This aspect will periodically update the alerting part of this system, in some embodiments.

In the embodiment shown in FIG. 1, an alerting module 112 issues an alert (e.g., sends a message, communicates with another system or an individual such as an administrator, etc.) if a specific access has a score, generated by the scoring module 110, that meets one or more rules in a rules data structure 120. That is, when the alerting module 112 receives a score from the scoring module for a data access, the alerting module 112 checks the rules data structure 120 and determines whether or not to issue an alert. In some embodiments, one or more thresholds or parameters of the rules are adjustable, as symbolized by the parameter adjustment 122 that is input to the rules data structure 120. Rules in the rules data structure 120 are associated to various aspects of users 106 and various aspects of the data in the content repository 104, for example by associations in a database or other type of data structure. The parameter adjustment 122 could be used to modulate a threshold, automatically or manually in various embodiments. For example, a server that has a greater amount of sensitive information could have a lower score threshold set for alerting. An individual with a greater likelihood of certain types of legitimate accesses could have a higher score threshold set for alerting. An individual under suspicion for other reasons could have a lower threshold set for alerting in some embodiments.

Rules for alerting could be customized for the activity score, the nature of the data, and the number of alerts that the administrator can reasonably handle, in various embodiments. For example, any user who has an anomalous access to financial data may be reported, but on non-financial data, a higher threshold will be required to bring the administrator's focus to that particular user. Some embodiments are not limited to reporting on users 106. Various embodiments could highlight a file server (i.e. a content repository 104) that has seen a significant amount of anomalous activity recently. The alerting module 112 could be selected or directed to alert regarding a user 106, regarding a file or other data, or regarding a specific content repository 104 (e.g., when monitoring multiple content repositories 104).

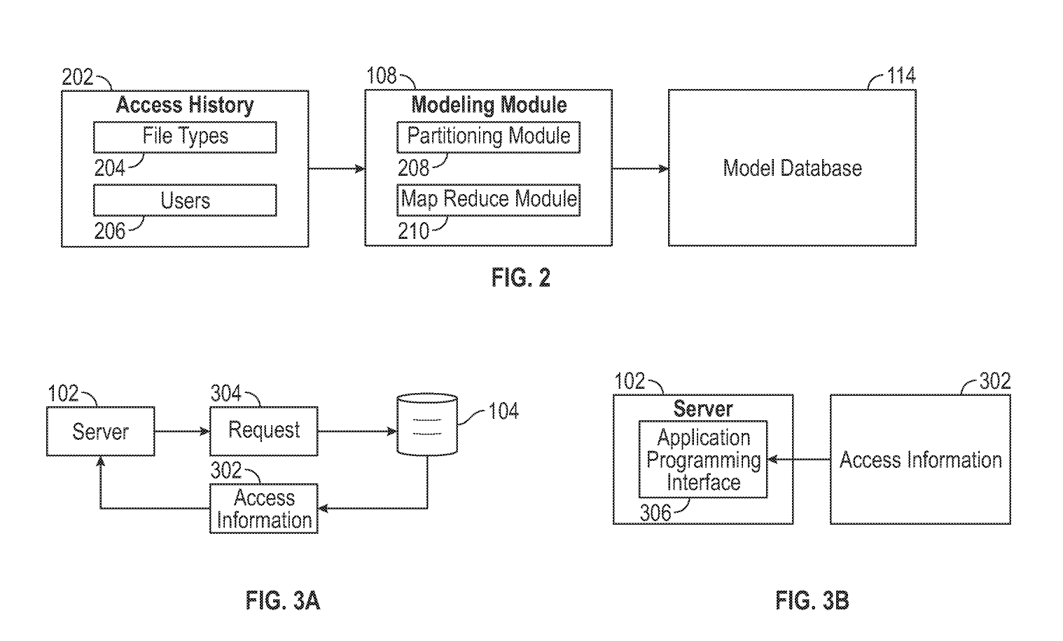

FIG. 2 is a block diagram depicting a modeling module 108 of the server 102 of FIG. 1, generating a model database 114 that is based on an access history 202 that has file types information 204 and users information 206. The modeling module 108 has a partitioning module 208 that partitions the access history 202 into various categories or subsets, so as to analyze dependencies and correlations to various aspects as discussed above. A MapReduce module 210 applies a MapReduce process, for rapid mapping and reduction of large amounts of data in parallel, or other suitable data processing, to generate the model database 114 in some embodiments. For example, the partitioning module 208 could partition the access history 202 as to accesses by users 206 belonging to a particular department, group or division in a company, office or government operation and as to particular types of data or aspects of data. The partitioning module 208 could partition data as to distribution among groups of users and/or as to ownership, e.g., by individuals, groups, departments or organizations. Information from directory attributes can be applied. From this partitioning, the modeling module 108 could develop models of particular trends for individuals, groups of individuals and types or aspects of data, which the MapReduce module 210 could then populate with probabilities from processing the information in the access history 202. The resultant models 116, 118 are then specific as to characteristics of data and characteristics of accessors.

For purposes of both model development and ongoing monitoring, FIGS. 3A-3D show various mechanisms for obtaining access information 302. Access information 302 specifies that a data access is taking place or has taken place, and specifies which user 106 (e.g., by username or other identifier) performs the access, and which data (e.g., by filename, database name, parameter name or other identifier of the data) in the content repository 104 is accessed. It should be appreciated that the access history 202 could be received from various sources, or could be collected from ongoing monitoring and receiving of the access information 302, and that the model database 114 could be developed initially and then modified (e.g., updated, refined, revised) as ongoing monitoring progresses. The mechanisms depicted below can be combined in various ways in various embodiments. Further mechanisms for obtaining access information 302, and for obtaining or collecting an access history 202 and performing ongoing monitoring, are readily devised.

FIG. 3A shows the server 102 of FIG. 1 requesting and receiving access information 302 from the content repository 104. In this scenario, the server 102 is pulling the access information 302, by issuing a request 304. The content repository 104, or an agent or other software, hardware or firmware acting on behalf of the content repository 104, sends the access information 302 in response to the request 304. This could be implemented as a form of polling, performed by the server 102 coupled to the content repository 104. FIG. 3B shows the server 102 of FIG. 1 receiving access information 302 via an application programming interface (API) 306. The server 102 hosts the API 306, and the access information 302 is written to the API 306, for example via the network 124 (see FIG. 1). The API could be specific to an embodiment described herein, or general as to data protection. Another server could host the API 306, in a further embodiment.

FIG. 3C shows the server 102 of FIG. 1 receiving access information 302 that is pushed by a data monitoring or governing tool 308. The data monitoring or governing tool 308 couples to the content repository 104, and observes data accesses (also called user accesses of data), and sends the access information 302 each time to the server 102. Unlike the example shown in FIG. 3A, the data monitoring or governing tool 308 would not wait for a request 304 from the server 102, but would push the access information 302 immediately, on an ongoing basis. A request 304 from the server 102 could be used, initially, to set up or initiate the service from the data monitoring or governing tool 308. FIG. 3D shows the server 102 of FIG. 1 receiving access information 302 that is pushed by a streaming tool 310. The streaming tool 310 couples to the content repository 104, and streams the access information 302 to the server 102.

FIG. 4 is a flow diagram of a method to detect malicious or risky data accesses, which can be practiced on or by the detection system of FIGS. 1-3D. The method can be practiced by a processor, such as a processor of a server configured for detection of malicious or risky accesses. In an action 402, a history of user accesses to a content repository is obtained. The history could be obtained all at once, or built over time from ongoing monitoring, etc. The history should have sufficient information so that a detailed model can be developed. In an action 404, a probabilistic model is generated, based on the history obtained in the action 402. The probabilistic model can consider various factors and aspects as discussed above with reference to FIGS. 1 and 2. In an action 406, user accesses to the content repository are monitored. This monitoring could employ one of the mechanisms discussed above with reference to FIGS. 3A-3D, or variation thereof.

In an action 408, for each user access to the content repository, as monitored in the action 406, the user access is scored according to the probabilistic model generated in the action 404. Scoring could be performed by a scoring module, as described above with reference to FIG. 1. In an action 410, for each user access to the content repository, as monitored in the action 406, the rules regarding alerting are consulted. This could be performed by the alerting module, using the score as generated in the action 408 and a rules data structure as described above with reference to FIG. 1. In the decision action 412, it is determined whether an alert is triggered. If an alert is triggered, the system alerts, in the action 414. For example, a message could be sent, the alert could be indicated, or other communication or action arranged. If an alert is not triggered, flow branches back to one of the actions 402, 404, 406, in order to obtain further history, or generate or revise the probabilistic model, and continue monitoring user accesses to the content repository.

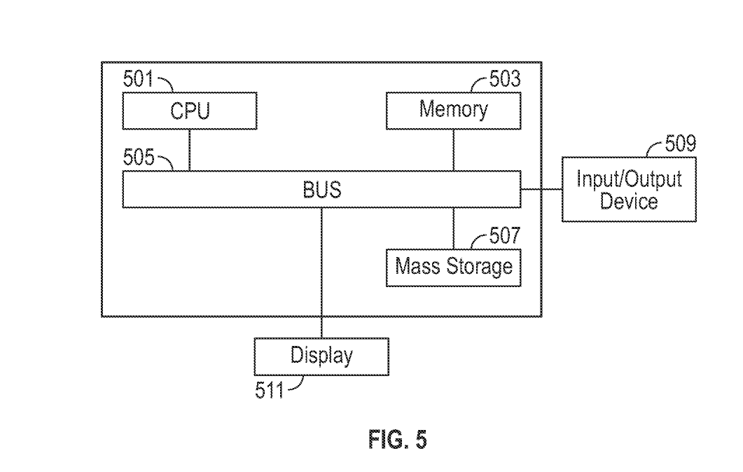

It should be appreciated that the methods described herein may be performed with a digital processing system, such as a conventional, general-purpose computer system. Special purpose computers, which are designed or programmed to perform only one function may be used in the alternative. FIG. 5 is an illustration showing an exemplary computing device which may implement the embodiments described herein. The computing device of FIG. 5 may be used to perform embodiments of the functionality for a detection system that detects malicious or risky data accesses in accordance with some embodiments. The computing device includes a central processing unit (CPU) 501, which is coupled through a bus 505 to a memory 503, and mass storage device 507. Mass storage device 507 represents a persistent data storage device such as a floppy disc drive or a fixed disc drive, which may be local or remote in some embodiments. The mass storage device 507 could implement a backup storage, in some embodiments. Memory 503 may include read only memory, random access memory, etc. Applications resident on the computing device may be stored on or accessed via a computer readable medium such as memory 503 or mass storage device 507 in some embodiments. Applications may also be in the form of modulated electronic signals modulated accessed via a network modem or other network interface of the computing device. It should be appreciated that CPU 501 may be embodied in a general-purpose processor, a special purpose processor, or a specially programmed logic device in some embodiments.

Display 511 is in communication with CPU 501, memory 503, and mass storage device 507, through bus 505. Display 511 is configured to display any visualization tools or reports associated with the system described herein. Input/output device 509 is coupled to bus 505 in order to communicate information in command selections to CPU 501. It should be appreciated that data to and from external devices may be communicated through the input/output device 509. CPU 501 can be defined to execute the functionality described herein to enable the functionality described with reference to FIGS. 1-4. The code embodying this functionality may be stored within memory 503 or mass storage device 507 for execution by a processor such as CPU 501 in some embodiments. The operating system on the computing device may be MS DOS™, MS-WINDOWS™, OS/2™, UNIX™, LINUX™, or other known operating systems. It should be appreciated that the embodiments described herein may be integrated with virtualized computing system also.

Detailed illustrative embodiments are disclosed herein. However, specific functional details disclosed herein are merely representative for purposes of describing embodiments. Embodiments may, however, be embodied in many alternate forms and should not be construed as limited to only the embodiments set forth herein.

It should be understood that although the terms first, second, etc. may be used herein to describe various steps or calculations, these steps or calculations should not be limited by these terms. These terms are only used to distinguish one step or calculation from another. For example, a first calculation could be termed a second calculation, and, similarly, a second step could be termed a first step, without departing from the scope of this disclosure. As used herein, the term “and/or” and the “/” symbol includes any and all combinations of one or more of the associated listed items.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

With the above embodiments in mind, it should be understood that the embodiments might employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing. Any of the operations described herein that form part of the embodiments are useful machine operations. The embodiments also relate to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

A module, an application, a layer, an agent or other method-operable entity could be implemented as hardware, firmware, or a processor executing software, or combinations thereof. It should be appreciated that, where a software-based embodiment is disclosed herein, the software can be embodied in a physical machine such as a controller. For example, a controller could include a first module and a second module. A controller could be configured to perform various actions, e.g., of a method, an application, a layer or an agent.

The embodiments can also be embodied as computer readable code on a tangible non-transitory computer readable medium. The computer readable medium is any data storage device that can store data, which can be thereafter read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer system so that the computer readable code is stored and executed in a distributed fashion. Embodiments described herein may be practiced with various computer system configurations including hand-held devices, tablets, microprocessor systems, microprocessor-based or programmable consumer electronics, minicomputers, mainframe computers and the like. The embodiments can also be practiced in distributed computing environments where tasks are performed by remote processing devices that are linked through a wire-based or wireless network.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

In various embodiments, one or more portions of the methods and mechanisms described herein may form part of a cloud-computing environment. In such embodiments, resources may be provided over the Internet as services according to one or more various models. Such models may include Infrastructure as a Service (IaaS), Platform as a Service (PaaS), and Software as a Service (SaaS). In IaaS, computer infrastructure is delivered as a service. In such a case, the computing equipment is generally owned and operated by the service provider. In the PaaS model, software tools and underlying equipment used by developers to develop software solutions may be provided as a service and hosted by the service provider. SaaS typically includes a service provider licensing software as a service on demand. The service provider may host the software, or may deploy the software to a customer for a given period of time. Numerous combinations of the above models are possible and are contemplated.

Various units, circuits, or other components may be described or claimed as “configured to” perform a task or tasks. In such contexts, the phrase “configured to” is used to connote structure by indicating that the units/circuits/components include structure (e.g., circuitry) that performs the task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. 112, sixth paragraph, for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method, performed by a processor to detect malicious or risky data accesses, comprising:
modeling user accesses to a content repository as to probability of a user accessing data in the content repository, based on a history of user accesses to the content repository;
scoring a singular user access to the content repository, based on probability of access according to the modeling; and
alerting in accordance with the scoring.

2. The method of claim 1, wherein the scoring includes a logarithm of an inverse of the probability of access.

3. The method of claim 1, wherein the scoring includes a weighted scoring based on metadata or content of a file involved in the singular user access.

4. The method of claim 1, wherein the singular user access is according to access information pulled to a server from the content repository, or pushed from the content repository to the server.

5. The method of claim 1, further comprising adjusting a scoring threshold for the alerting.

6. The method of claim 1, wherein the alerting is based on at least one rule that is customized for at least one of: an activity score, a nature of data, or a number of alerts.

7. The method of claim 1, wherein:
the content repository includes files;
the user accesses include user accesses to the files of the content repository; and
scoring the singular user access to a file in the content repository is based on how likely or unlikely is the singular user access to the file, according to at least one model produced by the modeling.

8. A tangible, non-transitory, computer-readable media having instructions thereupon which, when executed by a processor, cause the processor to perform a method comprising:
training a probabilistic model of data accesses, using a history of user accesses to a content repository;
monitoring user accesses to the content repository;
scoring each user access of a plurality of user accesses to data in the content repository as to how probable the user access is according to the probabilistic model; and
alerting in accordance with the scoring.

9. The computer-readable media of claim 8, wherein the probabilistic model is specific to at least one of: data types, file types, or users.

10. The computer-readable media of claim 8, wherein the alerting is regarding a user.

11. The computer-readable media of claim 8, wherein the alerting is regarding the content repository.

12. The computer-readable media of claim 8, wherein the method further comprises assigning a weighting in the scoring with the weighting based on a sensitivity of a file as assigned by a data loss prevention (DLP) service or module.

13. The computer-readable media of claim 8, wherein the probabilistic model includes a probability of a user accessing a specific file or specific type of file in the content repository during a time span.

14. A detection system for data accesses, comprising:
a server having a modeling module, a scoring module and an alerting module, and configured to receive information about user accesses to a content repository, for both history and ongoing monitoring;
the modeling module configured to produce a probabilistic model of user accesses to data in the content repository based on the history;
the scoring module configured to produce a score of a user access to the content repository, based on the ongoing monitoring and based on how probable is the user access to the content repository according to the probabilistic model; and
the alerting module configured to issue an alert based on a result of the scoring module.

15. The detection system of claim 14, wherein the probabilistic model is based at least in part on ages of files in the content repository.

16. The detection system of claim 14, wherein the probabilistic model is based at least in part on file extension or file origin of files in the content repository.

17. The detection system of claim 14, wherein:
the score is further based on a sensitivity of a file involved in the user access; and
the sensitivity is based on an access pattern of the file.

18. The detection system of claim 14, further comprising:
the modeling module further configured to partition the history into access information regarding file types and access information regarding users, wherein the probabilistic model includes modeling based on the file types and modeling based on the users.

19. The detection system of claim 14, further comprising:
a rules data structure coupled to the alerting module, the rules database including at least one rule regarding alerting relative to a type of data, wherein the alerting is in accordance with the rules data structure.

20. The detection system of claim 14, wherein the probabilistic model includes at least a portion of a model that is general across users and at least a portion of a model that is specific to individual users.
